(19) United States
(12) Patent Application Publication
(10) Pub. No.: US 2024/0005349 A1
(43) Pub. Date: Jan. 4, 2024

(54) METHODS AND SYSTEMS FOR ONLINE INVENTORY PRICING

(71) Applicant: TIRE TUTOR, Brookline, MA (US)

(72) Inventor: Jason Abrahams, Brookline, MA (US)

(73) Assignee: Tire Tutor, Brookline, MA (US)

(21) Appl. No.: 18/251,773

(22) PCT Filed: Nov. 4, 2021
(86) PCT No.: PCT/US21/57983

§ 371 Date: May 4, 2023

Related U.S. Application Data
(60) Provisional application No. 63/109,457, filed on Nov. 4, 2020.

(51) Int. Cl. G06Q 30/0201; G06Q 10/087

(52) U.S. Cl. CPC G06Q 30/0206; G06Q 10/087; G06Q 30/0601

(57) ABSTRACT

Novel methods and systems for delivering online, real time, inventory and pricing information to consumers.

### BACKGROUND

It can be very difficult for small, local companies to compete with large national retailers in competitive markets. Large national retailers typically have a significant online presence, and benefit from national marketing campaigns and brand recognition. In contrast, small, local companies do not have these advantages and may not have sufficient technological know-how or resources in order to establish a competitive online presence and/or reach local consumers who would be interested in their products.

This is particularly true in the automotive parts industry and specifically in the tire industry. While in the past a consumer might simply go to their local automotive shop for tire replacements, in these days of online comparative shopping, consumers frequently want to compare costs and find the best prices before leaving their homes. Small local retailers often struggle to deliver relevant market information, such as available inventory and pricing, to potential consumers.

Accordingly, novel, affordable, and easily accessible methods for local retailers to readily provide online real time inventory and pricing information to consumers are highly desirable.

### SUMMARY

According to various embodiments, the present disclosure provides novel methods and systems for delivering online, real time, inventory and pricing information to consumers.

### BRIEF DESCRIPTION OF THE DRAWINGS

FIG. 1 is a flowchart of a system for providing online, real-time, inventory and pricing information according to an embodiment of the present disclosure.

FIG. 2 is a flowchart of an exemplary pricing calculation according to an embodiment of the present disclosure.

### DETAILED DESCRIPTION

According to an embodiment the present disclosure provides novel methods and systems for providing online, real-time, inventory and pricing information. According to a specific embodiment, the disclosure provides a novel method for delivering online, real time, inventory and pricing information for small and/or local companies who may or may not themselves have an online presence. According to a more specific embodiment, the disclosure provides a novel method for tire companies to provide real time tire inventory and pricing information to their consumers via a simple and easy to use online platform.

It should be stated that while the present disclosure makes frequent mention of “small” and/or “local” companies, as it is believed such companies will be significant beneficiaries of the presently described inventions, the herein disclosed methods themselves are not limited in use to companies of any particular size, location, or distribution area. Furthermore, while the present disclosure may make reference to companies having a physical presence, i.e. “brick and mortar” companies, it will be understood that the presently described methods are not limited to such types of companies.

According to a specific embodiment, the present disclosure provides a website marketplace that works with local companies (i.e. tire companies, repair shops, mechanics, and other dealers or retailers) to deliver online, real time, inventory and pricing information customized for each individual retailer to potential consumers.

Like many consumer goods, tires are typically manufactured by large companies and then purchased by local retailers from wholesalers or resellers. Point-of-sale price points then typically depend on the base price paid by the local company to obtain the tire plus a markup which allows the local company to recoup their costs and make a profit. The amount of markup frequently varies from one local company to another, which can account for variations in point-of-sale price points.

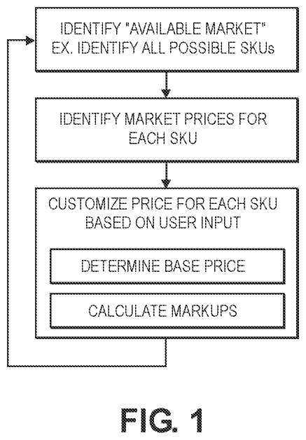

An exemplary method and system according to the disclosure will now be described with reference to FIG. 1. First, an “available market” representing the totality of products that will be included in the online marketplace is identified. One method for identifying the “available market” is by identifying the stock-keeping units (SKUs) for all possible products that could be offered in the online marketplace. A SKU is a unique code consisting of letters and numbers that identify the characteristics of a particular product, such as manufacturer, brand, style, color, and size. Products having identical SKUs would be assumed to be identical (absent, for example, manufacturer defects) while products having different SKUs are likely to be different in at least one characteristic (which may or may not be identifiable to the end consumer.) As an example, in the U.S. Market there are currently approximately 60,000 SKUs for automotive tires.

Next, market prices for each product (i.e. SKU) are obtained. Market prices may be obtained, for example, via market analysis, or acquired from a third party. A number of third party analytics firms and companies provide such information.

The SKUs and market prices are then analyzed to determine a customized price for each individual retailer. This customized price can be determined based on criteria provided by the retailer including, but not limited to, desired mark-up, inventory availability, day of the week, time of day, etc.

Finally, the system is updated to add new SKUs as new inventory becomes available and remove SKUs as inventory is depleted and adjust prices accordingly. According to an embodiment, the system analyzes SKUs and varying prices from different sources in the market, in order to make determinations on which SKUs are discontinued, or likely to be discontinued soon, thereby removing those SKUs from the available tire inventory and pricing on behalf of dealers. According to an embodiment, the system makes the determinations of which tires are still available in the market, and which tires have been discontinued, based upon price variances and availability of the same SKU being sold by different retailers or e-commerce sites, via market source information. Such updates may be performed periodically or continuously.

According to various embodiments, the system may appropriate SKUs and prices for a retailer based upon any number of configurations. A given retailer can have SKUs created in the system according to preferences of tire manufacturers, as well as market source prices, or File Transfer Protocol (FTP) data connections of inventory from distributors and wholesalers.

For each SKU, per retailer, a markup object is applied, dependent upon what is being analyzed—a tire, the type of tire, installation, etc. Markups can be percentage based or a fixed-dollar amount. Prices of tires, including tire installation costs, for a given retailer may be configured according to type of tire, size of tire, and preferred installation charges. Additionally, a given retailer can set their prices according to different schema options—such as min, max, median, and mode, of the data set analyzed for a given retailer.

As a non-limiting example, the consumer price of a particular tire may be calculated using four specific criteria: a wholesale price determined by the price the retailer can pay to purchase the tire (e.g. from a wholesaler, reseller, etc.), one or more unit markup(s) based, for example, on the tire rim size or other factors, a markup for installation, and a markup based on type of tire such as run flat. Importantly, each of these criteria can be customized. For example, the wholesale price may be based on the minimum purchase price available, the maximum purchase price available, the median purchase price available, the mean purchase price available, or some other basis. Furthermore, markups can be calculated as a set amount, as a percentage of the wholesale price, as a percentage of the wholesale price plus any unit markup(s) or using some other criteria. For example, the markup for rim sizes greater than X inches could be $Y while the markup for all other rim sizes is $Z. The installation price could be determined as a given percentage of the base price plus the unit markup for rim sizes greater than X inches and another percentage of the base price plus unit markup for all other rim sizes. Finally, an additional markup for tire type (i.e. run flat) could also be determined as a given percentage of the base price plus the unit markup for rim sizes greater than X inches and another percentage of the base price plus unit markup for all other rim sizes.

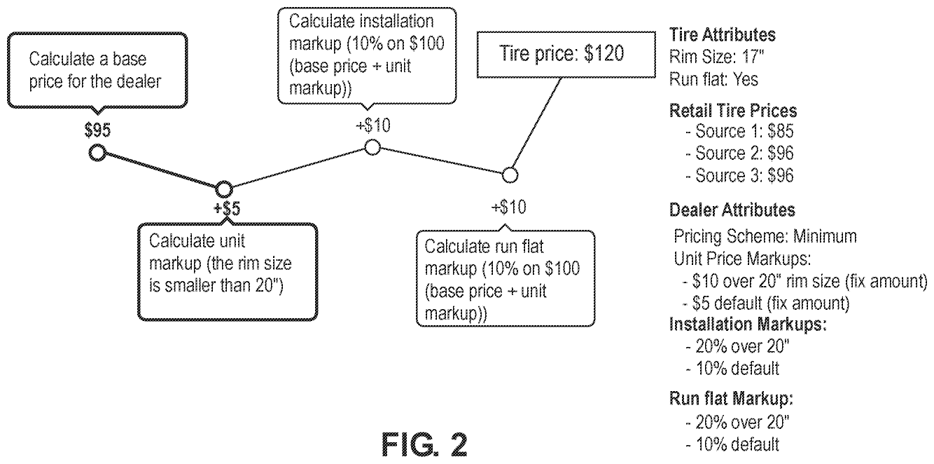

FIG. 2 depicts an exemplary embodiment wherein an end-use customer wants to purchase a tire with a 17″ rim and run flat. In this particular embodiment, the retailer has set the base price to be determined by the minimum available price, the unit markup to be determined by rim size, the installation markup to be determined as 10% of the base price+unit markup for tires with a rim size of 20″ or less and 20% of the base price+unit markup for tires with a rim size greater than 20″, and a run flat markup of 10% of the based price+unit markup for tires with a rim size of 20″ or less and 20% of the base price+unit markup for tires with a rim size greater than 20″. Accordingly, once the system receives the customer's query, the system identifies wholesale prices for the particular tire identified by the customer. In the example shown in FIG. 2, the tire the customer wants to purchase is available at three different wholesale prices: $95, $96, and $98. Accordingly, the base price is set to $95 (the minimum available price.) Because the customer has selected a tire with 17″ rims, the unit markup is $5, the installation markup is $10 (10% of $100 ($95 base price+$5 unit markup)) and the run flat markup is $10 (10% of $100 ($95 base price+$5 unit markup)), making the total price to the consumer $120. Of course it will be understood that the particular markups and calculations shown in FIG. 2 are merely exemplary and that numerous calculations and variations could be utilized while still being within the scope of the present disclosure.

According to an embodiment, some or all the above-described method is performed by computer software which may, for example, utilize algorithms to: obtain market SKUs, obtain current market prices, determine the customized price for each retailer, and/or update inventory SKUs. According to a specific embodiment, the entire process is automated and performed by computer software.

According to an embodiment, the system provides retailer with a retailer user interface where the retailer can select the specific criteria by which their individualized, real-time inventory pricing is determined. For example, the user interface may present the retailer with a series of pricing factors with pre-determined selectable or open-ended options. For example, the user interface may offer the retailer the opportunity to choose a base price based on a number of pricing schemes: minimum (i.e. the minimum purchase price available), maximum (i.e. the maximum purchase price available), median (e.g., the median purchase price available) or mean (e.g., the mean purchase price available). The user interface may offer the retailer the opportunity to select a unit markup based on one or more criteria, including, for example, sub criteria. For example, the retailer may be offered the opportunity to set the unit markup based on rim size. If the retailer selects this option, the retailer may then select or input different markup prices for different rim sizes. The user interface may offer the retailer the opportunity to select an installation markup and a basis for the markup (i.e. flat price, flat price+unit markup, percentage of base price, percentage of base price+unit markup(s), etc.) The installation markup may also depend on or vary with other criteria. For example, the installation markup may be a given percentage, such as 20% for units in one category (i.e. tires with rim sizes larger than 20″) and 10% for all other units. The user interface may offer the retailer the opportunity to set additional markups (for example for tire type), which, like the installation markup, could be determined by any suitable method including, but not limited to, flat price, flat price+unit markup, percentage of base price, percentage of base price+unit markup(s), and which may or may not depend on or vary with other criteria (such as, but not limited to, tire rim size).

According to an embodiment, the retailer user interface enables the retailer to make real-time pricing changes which can be instantly reflected on the retailer's point-of-sale pricing (for example, on their website.) This enables the retailer to easily and instantly change their prices as frequently as they want—for example, to create promotions, sales, or respond to market conditions.

According to another embodiment, the system may further include a customer user interface that allows the retailer to provide to the customer the opportunity to select and price tires from the retailer's available inventory with any criteria, services, or other add-ons that the retailer has decided to make available.

It will be appreciated that according to an embodiment, some or all of the steps described herein are performed automatically by a computer-based system operating one or more computer program. For the purposes of the present disclosure, it will be understood that the term “automatically” refers to the performance of a task or action by the computer-based system and/or computer program without any additional input or intervention from a human user.

For the purposes of the present disclosure, a computer-based system may incorporate one or more data processing apparatus (processors, cores, etc.) operating one or more modules of computer programs instructions encoded on a computer-readable medium for execution by, or to control the operation of, the data processing apparatus. The computer-readable medium can be a machine-readable storage device, a machine-readable storage substrate, a memory device, a composition of matter affecting a machine-readable propagated signal, or any combination or sub-combination thereof. In addition to hardware, code that creates an execution environment for the computer program(s) may be provided, such code may constitute processor firmware, a protocol stack, a database management system, an operating system, a user interface, or the like.

A computer program (also known as a program, software, software application, script, code, etc.) used to provide the functionality described herein can be written in any form of programming language, including compiled or interpreted languages, and it can be deployed in any form, including as a stand-alone program or as a module, component, subroutine, or other unit suitable for use in a computing environment.

The specific methods and systems described herein are representative of preferred embodiments and are exemplary and not intended as limitations on the scope of the invention. Other objects, aspects, and embodiments will occur to those skilled in the art upon consideration of this specification and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims.

What is claimed is:

1. A method for delivering real time retailer-specific online pricing and information to a consumer comprising:
identifying an available market for a totality of products that are offered in an online marketplace, wherein the online marketprice offers an inventory of currently available products to end-use consumers;
obtaining one or more retailer-specified criteria regarding desired adjustments to the market price of the products;
receiving a query from a consumer related to a particular good offered in the online marketplace;
identifying a real-time market price for the good;
automatically adjusting the market price based on the one or more retailer-specified criteria; and
reflecting the adjusted market price to the consumer in real time.

2. The method of claim 1 wherein the good is a tire.

3. The method of claim 1 wherein the step of identifying the available market comprises identifying the stock-keeping units (SKUs) for all products that are offered in the online marketplace.

4. The method of claim 3 wherein identifying SKUs for all products comprises querying one or more databases provided by one or more product sources to determine the current availability status of each SKU.

5. The method of claim 4 wherein identifying the available market comprises updating the inventory in the online marketplace to remove SKUs which are not available and add newly available SKUs.

6. The method of claim 5 comprising periodically and repeatedly querying the one or more databases such that the inventory in the online marketplace reflects real-time availability.

7. The method of claim 1 wherein the retailer-specified criteria comprise a specified method for determining the base price of one or more goods offered in the online marketplace.

8. The method of claim 7 wherein the base price is the lowest available wholesale price for a particular good as determined by querying one or more databases provided by one or more product sources.

9. The method of claim 1 wherein the retailer-specified criteria comprise a unit markup.

10. The method of claim 9 wherein the unit markup differs based on one or more factors associated with the good.

11. The method of claim 10 wherein the good is a tire and the factor is rim size.

12. The method of claim 9 wherein the unit markup is based on the base price.

13. The method of claim 12 wherein the unit markup is a percentage of the base price.

14. The method of claim 12 wherein the unit markup is based on one or more factors associated with the good.

15. The method of claim 1 wherein the retailer-specified criteria comprises an added cost for one or more services provided by the retailer.

16. The method of claim 15 wherein the cost for the service is based on the base price.

17. The method of claim 15 wherein the cost for the service is based on one or more factors associated with the good.

18. The method of claim 15 wherein the good is a tire and the service is installation.
